(19) United States
(12) Patent Application Publication
(10) Pub. No.: US 2024/0292433 A1
(43) Pub. Date: Aug. 29, 2024

(54) TRANSMIT PARAMETER FOR PORTION OF SIDELINK RESOURCE POOL

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US)

(21) Appl. No.: 18/174,157

(22) Filed: Feb. 24, 2023

(51) Int. Cl. H04W 72/40; H04W 72/51

(52) U.S. Cl. CPC H04W 72/40; H04W 72/51

(57) ABSTRACT

Various aspects of the present disclosure generally relate to wireless communication. In some aspects, a user equipment (UE) may receive a configuration of a portion of a sidelink resource pool, the configuration indicating at least one transmit parameter specific to the portion of the sidelink resource pool. The UE may communicate based at least in part on the at least one transmit parameter. Numerous other aspects are described.

### FIELD OF THE DISCLOSURE

Aspects of the present disclosure generally relate to wireless communication and to techniques and apparatuses for transmit parameters for a portion of a sidelink resource pool.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a configuration of a portion of a sidelink resource pool, the configuration indicating at least one transmit parameter specific to the portion of the sidelink resource pool. The method further includes communicating based at least in part on the at least one transmit parameter.

Another aspect provides a method for wireless communication by a network entity. The method includes outputting a first configuration of a first portion of a sidelink resource pool, the first configuration indicating at least one first transmit parameter specific to the first portion of the sidelink resource pool. The method further includes outputting a second configuration of a second portion of the sidelink resource pool, the second configuration indicating at least one second transmit parameter specific to the second portion of the sidelink resource pool.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network.

FIG. 2 depicts aspects of an example base station (BS) and user equipment (UE).

FIG. 3 depicts an example disaggregated base station architecture.

FIGS. 4A, 4B, 4C, and 4D depict aspects of data structures for a wireless communications network in accordance with the present disclosure.

FIG. 5 is a diagram illustrating an example of sidelink communications.

FIG. 6 is a diagram illustrating an example of sidelink communications and access link communications.

FIG. 7 is a diagram illustrating an example of candidate resource identification based at least in part on sensing.

FIG. 8 illustrates example operations for resource allocation using resource allocation mode 2.

FIG. 9 illustrates example techniques for resource reservations.

FIG. 10 is a diagram illustrating an example of signaling regarding a portion of a sidelink resource pool.

FIG. 11 shows a method for wireless communications by a UE.

FIG. 12 shows a method for wireless communications by a network entity.

FIG. 13 is a diagram illustrating an example of an implementation of code and circuitry for a communications device.

FIG. 14 is a diagram illustrating an example of an implementation of code and circuitry for a communications device.

### DETAILED DESCRIPTION

Aspects of the present disclosure provide apparatuses, methods, processing systems, and computer-readable mediums for transmit parameters for a portion of a sidelink resource pool.

Wireless communication devices, such as user equipments (UEs), may communicate with one another without the direct involvement of a network entity such as a gNB. Among UEs, such direct communication may be referred to as sidelink communication. Sidelink communication may occur on a configured set of time and frequency resources referred to as a sidelink resource pool (sometimes referred to as a resource pool). UEs performing sidelink communications may be referred to as sidelink UEs. Some sidelink UEs may be considered baseline (e.g., normal, enhanced mobile broadband) UEs, whereas other sidelink UEs may be associated with reduced capabilities (referred to herein as UEs having a threshold capability). UEs having the threshold capability may be capable of using, or configured to use, a smaller communication bandwidth than baseline UEs. In some examples, the bandwidth of a sidelink resource pool may exceed the communication bandwidth of a UE having a threshold capability. It may be beneficial to configure a portion of a sidelink resource pool (e.g., a proper subset of the bandwidth of the sidelink resource pool) for communication by a UE having a threshold capability.

However, UEs having a threshold capability may have different communication capabilities than baseline UEs, while transmit parameters of a sidelink resource pool may be configured at the granularity of the entire sidelink resource pool. If transmit parameters of the sidelink resource pool are configured at the granularity of the sidelink resource pool, capabilities of UEs having a threshold capability may be exceeded, leading to subpar performance of the UEs having the threshold capability. For example, a UE having a threshold capability may have a lower capability for interference mitigation or transmit power than a baseline UE. If baseline UEs use a transmit power parameter, configured across the entire sidelink resource pool, for communication in the portion of the sidelink resource pool configured for the UE having the threshold capability, then the lower capabilities of the UE having the threshold capability may lead to increased interference and decreased effectiveness of communication of the UE.

Some techniques described herein provide configuration of a transmit parameter for a portion of a sidelink resource pool. By configuring the transmit parameter for the portion of the sidelink resource pool (as opposed to an entirety of the sidelink resource pool), the capabilities of UEs having a threshold capability, for which the portion of the sidelink resource pool may be configured for communication, can be taken into account, thereby improving performance of such UEs. For example, a transmit parameter may indicate a power control parameter, which may be used by a baseline UE when communicating in the portion of the sidelink resource pool. The power control parameter may cause the baseline UE to use a lower transmit power in the portion of the sidelink resource pool than in the remainder of the sidelink resource pool, thereby reducing interference for UEs having a threshold capability and improving effectiveness of communications of such UEs (without having to increase the transmit power of such UEs).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

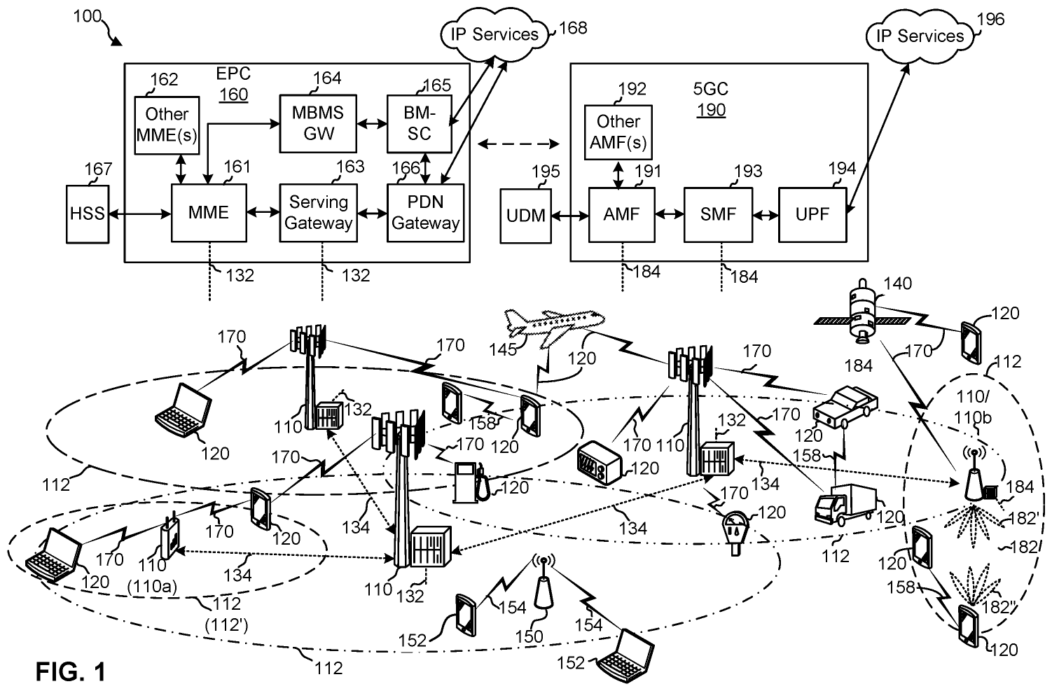

FIG. 1 depicts an example of a wireless communications network 100.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

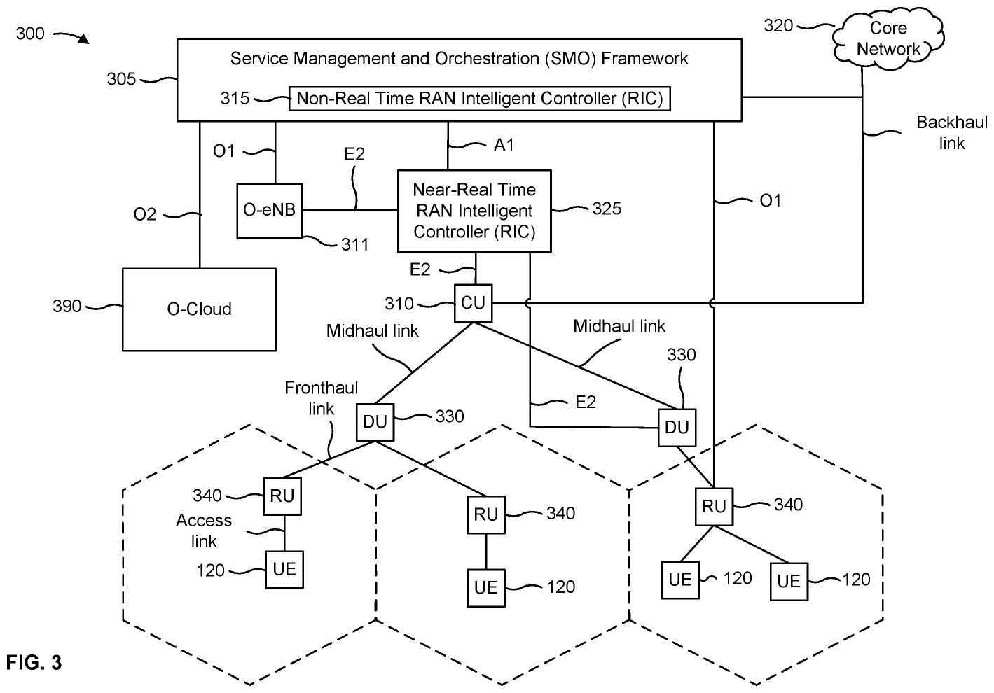

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

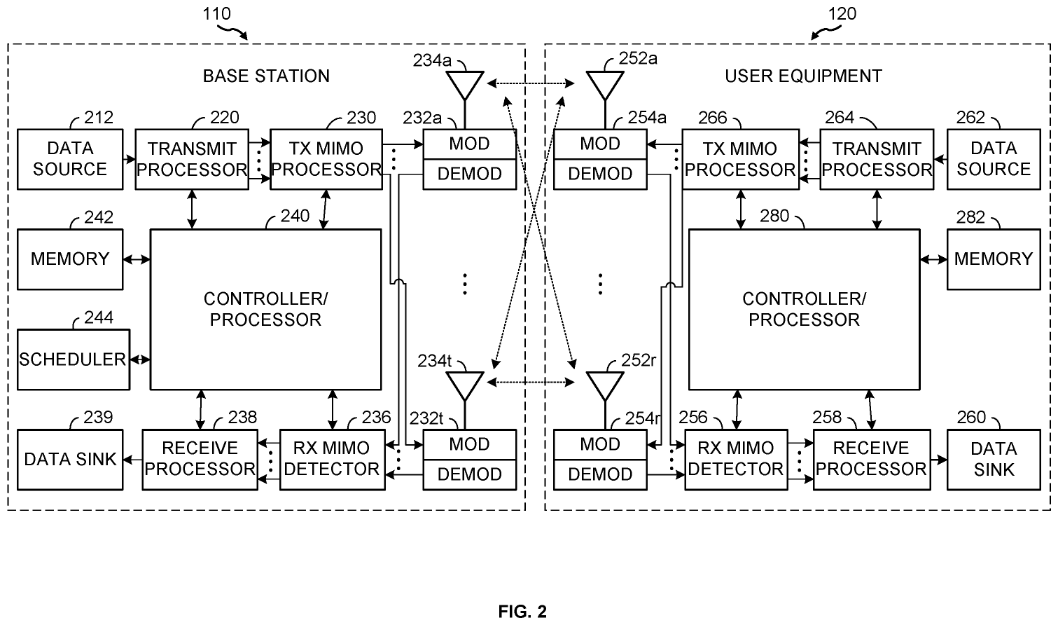

FIG. 2 depicts aspects of an example BS 110 and UE 120.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an 01 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

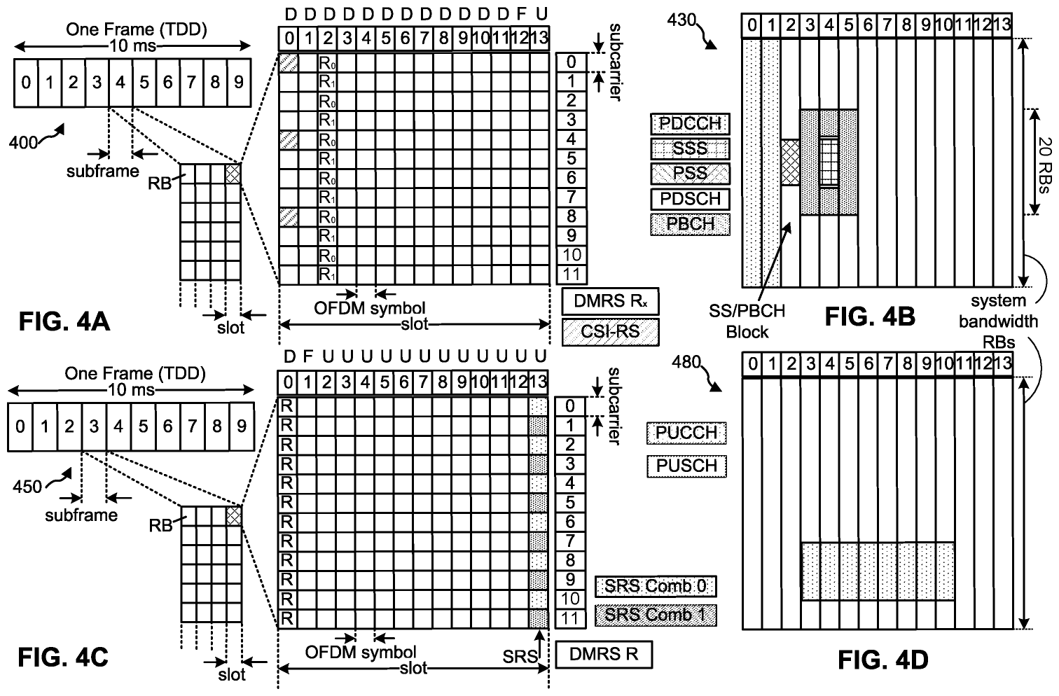

FIGS. 4A, 4B, 4C, and 4D depict aspects of data structures for a wireless communications network, such as wireless communications network 100 of FIG. 1. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

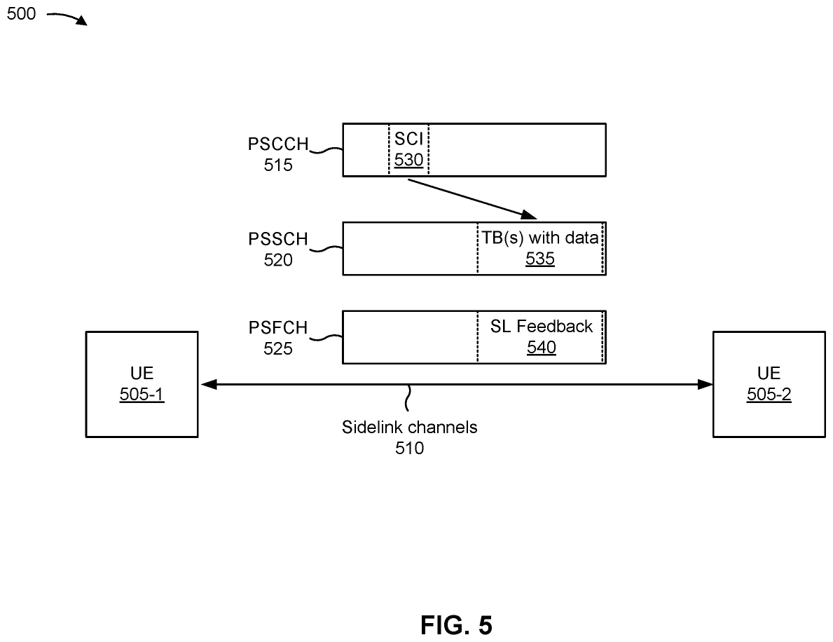

FIG. 5 is a diagram illustrating an example 500 of sidelink communications.

As shown in FIG. 5, a first UE 505-1 may communicate with a second UE 505-2 (and one or more other UEs 505) via a sidelink using one or more sidelink channels 510. The UEs 505-1 and 505-2 may communicate using the one or more sidelink channels 510 for peer-to-peer (P2P) communications, device-to-device (D2D) communications, vehicle-to-anything (V2X) communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 505 (e.g., UE 505-1 and/or UE 505-2) may correspond to one or more other UEs described elsewhere herein, such as UE 120 (which may be a baseline UE or a UE having a threshold capability). In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a BS 110 via an access link or an access channel. The PSSCH 520 may be used to communicate data, similar to a physical downlink shared channel (PDSCH) and/or a physical uplink shared channel (PUSCH) used for cellular communications with a BS 110 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a hybrid automatic repeat request (HARQ) process ID, a new data indicator (NDI), a source identifier, a destination identifier, and/or a channel state information (CSI) report trigger.

In some aspects, the one or more sidelink channels 510 may use sidelink resource pools. A sidelink resource pool may include a configured set of time and frequency resources in which sidelink UEs 505 perform sidelink communications. A UE can be configured with one or more sidelink resource pools. A sidelink resource pool may be defined by a number of consecutive sub-channels, which may each be composed of a number of consecutive resource blocks or resource elements. A configuration of a sidelink resource pool may indicate transmit parameters for UEs 505 communicating in the sidelink resource pool, as described in more detail elsewhere herein. A scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a BS 110 (e.g., a gNB, a CU, or a DU). For example, the UE 505 may receive a grant (e.g., in downlink control information (DCI) or in a radio resource control (RRC) message, such as for configured grants) from the BS 110 (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a BS 110). In some aspects, the UE 505 may perform resource selection and/or scheduling by sensing channel availability for transmissions. For example, the UE 505 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or a modulation and coding scheme (MCS) to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

In some aspects, a UE 505 may be a baseline UE (e.g., a smartphone, a premium smartphone, an eMBB device, or the like). In some other aspects, a UE 505 may be a UE having a threshold capability (e.g., a capability lower than the threshold). A UE having a threshold capability may include, for example, a reduced capability (RedCap) UE, a superlight UE, an ultralight UE, or the like. A UE having a threshold capability may be subject to relaxed peak throughput, latency, and/or reliability requirements. A threshold capability may include, for example, a communication bandwidth capability, a transmit power capability, a power storage capability, a sensing capability, or a combination thereof, among other examples. Examples of UEs having threshold capabilities include a metering device, an asset tracking device, and a personal IoT device. Implementation of UEs having threshold capabilities in the sidelink may enable low power wide area (LPWA) use cases, such as improvements in coverage, complexity, and power consumption, as well as utilization of low-power and/or low-complexity sidelink devices. Implementation of UEs having threshold capabilities May also enable power-efficient sidelink operation, such as in relay use cases (in which power savings are achieved by avoiding large numbers of repetitions for coverage extension) and wearable or in-home networking use cases (since short-distance sidelink communication may use less power than long-distance downlink or uplink communication).

As indicated above, FIG. 5 is provided as an example. Other examples may differ from what is described with respect to FIG. 5.

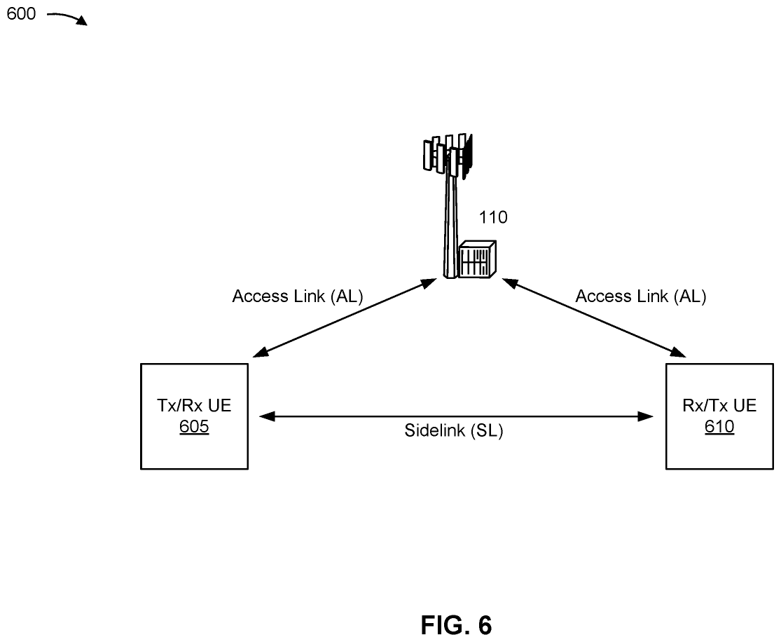

FIG. 6 is a diagram illustrating an example 600 of sidelink communications and access link communications.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a network node 110 may communicate with the Tx/Rx UE 605 (e.g., directly or via one or more network nodes), such as via a first access link. Additionally, or alternatively, in some sidelink modes, the network node 110 may communicate with the Rx/Tx UE 610 (e.g., directly or via one or more network nodes), such as via a first access link. The Tx/Rx UE 605 and/or the Rx/Tx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 6 is provided as an example. Other examples may differ from what is described with respect to FIG. 6.

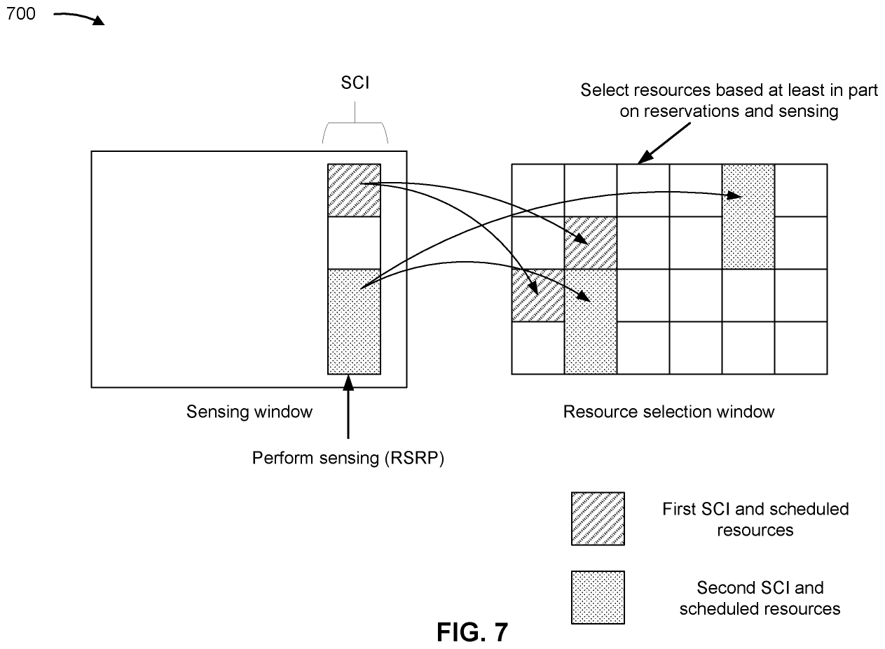

FIG. 7 is a diagram illustrating an example 700 of candidate resource identification based at least in part on sensing. Example 700 relates to a mode where UEs (e.g., UE 120, UE 505, UE 605, UE 610, a UE having a threshold capability, a baseline UE) of a sidelink network autonomously determine resource allocations. Example 700 includes a sensing window and a resource selection window. In the sensing window, a UE may decode SCI, such as to determine whether a resource in the resource selection window is available or not. SCI may indicate a resource reservation, and may indicate a priority level associated with the resource reservation. In example 700, the resources reserved by each SCI are indicated by a matching fill and an arrow from the SCI to the reserved resource.

The UE may perform sensing with regard to the SCI in the sensing window. For example, the UE may determine a measurement such as a reference signal received power (RSRP) measurement with regard to the SCI. The UE may select resources in the resource selection window based at least in part on the measurement. Thus, the measurement of the transmission associated with the SCI may be said to be projected onto the resource selection window. The UE may measure the RSRP on a PSCCH, a PSSCH (e.g., a DMRS of the PSSCH), or the like, according to a configuration (e.g., an RRC configuration, a preconfiguration, or the like). The sensing window may have a length, which may be configured (e.g., RRC configuration, preconfiguration, or the like). The configurations used for determination of the resource selection window and the sensing window may be collectively referred to as a set of parameters, and are described in more detail elsewhere herein.

The UE may select resources based at least in part on the measurement and/or the priorities, which may be referred to as resource exclusion (where excluded resources are not selected). For example, the UE may determine whether a resource in the resource selection window is associated with SCI in the sensing window for which an RSRP satisfies a threshold (e.g., a threshold for single-slot transmission, as described above). If the RSRP satisfies the threshold (e.g., if the RSRP is sufficiently strong), the UE may determine that the reserved resource is unavailable. If the RSRP fails to satisfy the threshold, the resource is considered available. In some aspects, the UE may determine resource availability based at least in part on a priority level. For example, the UE may disregard reservations associated with lower priority levels than a communication to be performed by the UE, or the UE may modify one or more thresholds associated with resource selection based at least in part on the priority levels. In some aspects, the threshold for the RSRP may be configured per transmitter priority (e.g., prio_{TX}) and receiver priority (e.g., prio_{RX}) pair, meaning that a threshold is specific to a priority level associated with a transmitter of a communication and a receiver of the communication. In some aspects, the UE may adjust the threshold for the RSRP. For example, if the proportion of available resources in the resource selection window is less than a threshold (e.g., 20%), then the RSRP threshold may be increased, and the process may be repeated.

Available resources in the resource selection window may form a candidate resource set. The UE may report the candidate resource set to a higher layer of the UE (e.g., higher than the PHY layer). Resources for a transmission (e.g., a packet) may be selected such that all retransmissions for the transmission occur within a delay budget (e.g., a packet delay budget) associated with the packet.

The UE (e.g., a layer of the UE) may receive or determine a resource selection trigger. A resource selection trigger indicates that the UE is to perform a transmission, so resources are to be selected. The UE may look back in time, upon receiving the resource selection trigger, to the sensing window based at least in part on a configured or preconfigured time window. The UE may select future resources in the resource selection window based at least in part on the sensing window.

As indicated above, FIG. 7 is provided as an example. Other examples may differ from what is described with regard to FIG. 7.

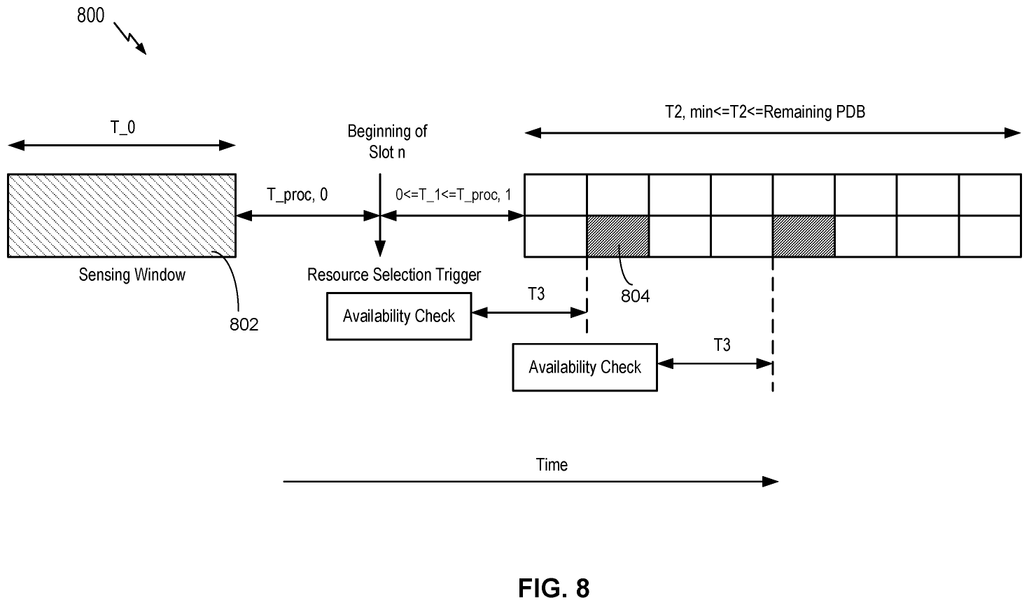

FIG. 8 illustrates example operations 800 for resource allocation using resource allocation mode 2. A higher layer may request a UE (e.g., UE 120, UE 505, UE 605, UE 610, a UE having a threshold capability, a baseline UE), via a resource selection trigger, to determine a subset of resources from which the higher layer may select resources for PSSCH/PSCCH transmissions.

To trigger resource selection at a slot n, the higher layer may provide a number of parameters including a t2min_SelectionWindow parameter. T_{2,min} may be set to a corresponding value from the higher layer parameter t2min_SelectionWindow for a given value of prio_{TX} that indicates configured priority {1, 8, 10, 20}·2^{μ}, where μ may equal to {0, 1, 2, 3} for subcarrier spacing (SCS) {15, 30, 60, 120} kHz, respectively.

If T_{2,min} is shorter than a remaining packet delay budget (PDB) (in slots), then T₂ may be determined by the UE and T_{2,min} may be less than or equal to 72, which may be less than or equal to the remaining packet delay budget. T_{2,min} may be referred to as a second time length defining a minimum length of a resource selection window. If T_{2,min} is not shorter than a remaining packet delay budget, resource selection window size T₂ may be set to the remaining packet delay budget. The higher layer may also indicate a parameter T₀ which indicates the sensing window size (e.g., a number of slots). T₀ may be referred to as a first time length defining a sensing window. The sensing window may be defined by a range of slots n−T_{proc,0} (e.g., beginning of slot n minus a time duration T_{proc,0}, as shown). The UE may monitor slots which may belong to a sidelink resource pool within the sensing window except for those in which the UE's own transmissions occur. The UE may decode the SCI received from other UEs during the sensing window. The UE may determine resources reserved via the SCIs. For example, a sensing UE may receive SCI during the sensing window 802 that is transmitted by another UE. The SCI during the sensing window may reserve resource 804 for transmission.

Each UE may attempt to reserve resources in the future that may collide with the resource selection window of the UE of interest. For example, the sensing UE (e.g., the UE of interest) may attempt to reserve resources during the resources 804. Based on a priority of the packet for which another UE is reserving a resource (pⱼ) (e.g., resource 804), the priority of the packet of the UE of interest (pᵢ), the configured RSRP for the (pᵢ,pⱼ) pair, and the measured RSRP by the UE of interest (based on the reception of PSCCH/PSSCH (e.g., including SCI) from the other UE), the UE of interest may determine whether a candidate resource (e.g., resource 804) is considered as available or not (i.e., is considered as a candidate resource for selection). Thus, the UE of interest may determine whether using the resource 804 may cause interference with the other UE. If the proportion of available resources in the resource selection window is less than a threshold (e.g., 20%), the threshold may be increased in accordance with a step size and the process is repeated. Available resources in the selection window form the candidate resource set. The candidate resource set is reported to higher layers. Resources may be selected such that all retransmissions for a packet must occur within the packet's PDB.

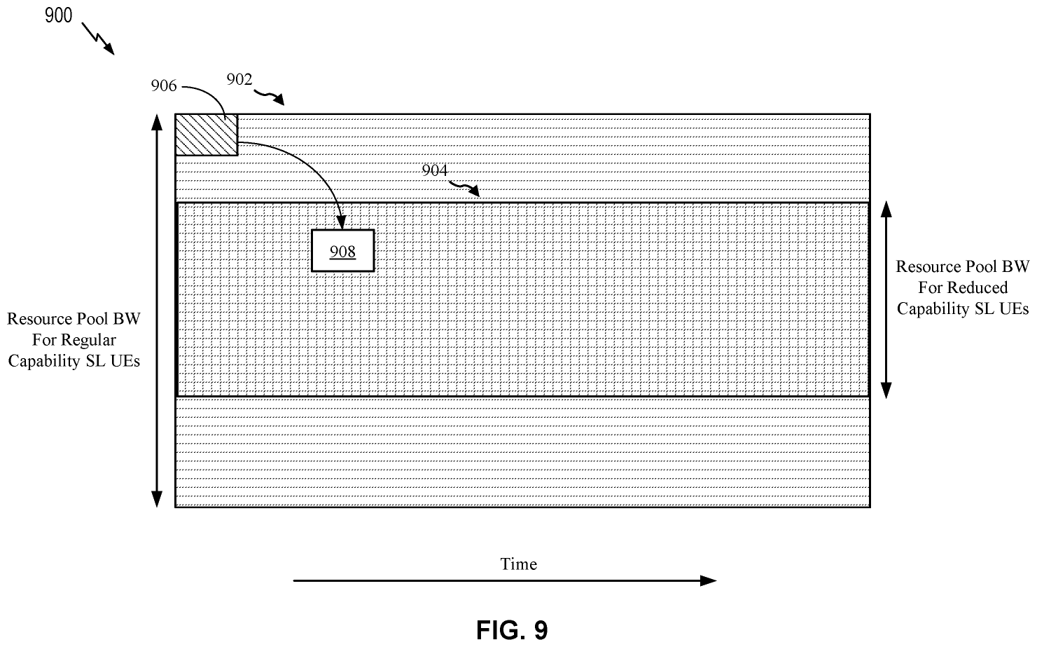

FIG. 9 illustrates example techniques 900 for resource reservations. A sidelink resource pool 902 for baseline UEs (e.g., non-reduced capability UEs, UEs having greater than a threshold capability) may be overlapping with (e.g., encompassing) a portion 904 of the sidelink resource pool 902 for UEs having a threshold capability (e.g., UEs having at most the threshold capability). As described herein, UEs having a threshold capability may operate on a narrower bandwidth (e.g., portion 904), allowing such UEs to operate with lower power consumption than baseline UEs.

In some aspects, a UE having a threshold capability may operate in a fraction of the bandwidth of the resource pool 902. When a baseline UE reserves a set of resources 908 in the portion 904 via signaling 906 on resources that are not part of the portion 904, the UEs having a threshold capability may not be able to sense the signaling 906 in order to consider the resource 908 when performing reservations. Therefore, collision (which may be power consuming for the reduced capability UEs as it may result in retransmissions) may occur. Reservations made by UEs having a threshold capability may be detected by baseline UEs since baseline UEs are able to sense the entirety of the resource pool 902, which includes the portion 904.

A sidelink resource pool can be for transmission of PSSCH, or for reception of PSSCH, and can be associated with either sidelink resource allocation mode 1 or sidelink resource allocation mode 2. For resource allocation mode 1, the sidelink (SL) resources for transmission may be indicated by a network entity dynamically via DCI format 3_0 or configured. Both Type 1 (solely configuration based) and Type 2 (activation based) SL resource configurations are supported. Resource allocation mode 2 is an autonomous mode in which a UE selects resources for its SL transmission based on sensing and reservation. In the frequency domain, a sidelink resource pool includes numSubchannel contiguous sub-channels. A sub-channel includes subchannelsize contiguous PRBs, where numSubchannel and subchannelsize are higher layer parameters.

As indicated above, FIG. 9 is provided as an example. Other examples may differ from what is described with regard to FIG. 9.

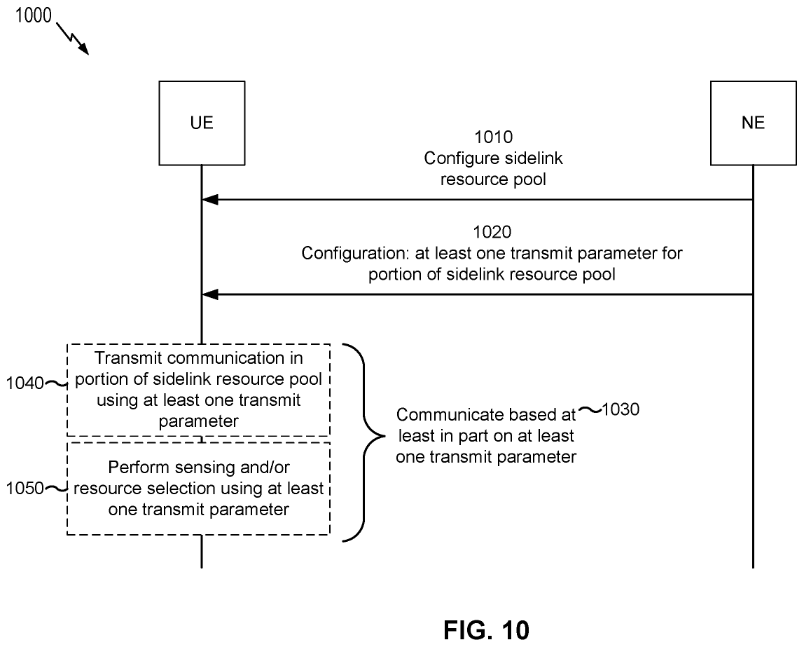

FIG. 10 is a diagram illustrating an example 1000 of signaling regarding a portion of a sidelink resource pool. Example 1000 includes a network entity (e.g., BS 110, one or more entities of a disaggregated base station described in connection with FIG. 3, a programmable logic controller, a controller UE of a sidelink) and a UE (e.g., UE 120, UE 505, UE 605, UE 610, a baseline UE, a UE having a threshold capability).

As shown in FIG. 10, and by reference number 1010, the network entity may configure a sidelink resource pool (e.g., sidelink resource pool 902). For example, the network entity may transmit a resource pool configuration indicating parameters defining the sidelink resource pool, such as one or more of the parameters described with regard to FIG. 9.

As shown by reference number 1020, the network entity may transmit, and the UE may receive, a configuration of a portion (e.g., portion 904, a sub-band) of the sidelink resource pool. In some aspects, the network entity may transmit the configuration shown by reference number 1020 as part of the configuration of the sidelink resource pool. In some other aspects, the network entity may transmit the configuration separately from (e.g., after) the configuration of the sidelink resource pool. In some aspects, the network entity may configure multiple portions of a sidelink resource pool. Each portion may be configured via a respective configuration. At least one transmit parameter may differ from one portion to another. For example, a first configuration of a first portion of a sidelink resource pool may indicate at least one first transmit parameter specific to the first portion of the sidelink resource pool, and a second configuration of a second portion of the sidelink resource pool may indicate at least one second transmit parameter specific to the second portion of the sidelink resource pool. The at least one second transmit parameter may be different than the at least one first transmit parameter. Portions of a given sidelink resource pool can be overlapped with one another or non-overlapped with one another. In some aspects, a baseline UE may communicate using the configuration of the portion of the sidelink resource pool. For example, the configuration may indicate a diminished transmit power in the portion of the sidelink resource pool, since the portion of the sidelink resource pool is shared with UEs having a threshold capability. The baseline UE may determine that the portion is shared with the UEs having the threshold capability according to a dynamic indication, the configuration, or sensing in the portion, as described elsewhere herein.

In some aspects, the configuration may include one or more parameters indicating a difference (a “delta”) between the sidelink resource pool configuration and the configuration of the portion of the sidelink resource pool. For example, the configuration may indicate one or more first parameters for a first portion of the sidelink resource pool and one or more second parameters for a second portion of the sidelink resource pool. If the UE uses multiple portions of the sidelink resource pool, such as due to frequency hopping across time, the UE may use a set of parameters for a portion of the sidelink resource pool currently in use by the UE. If no set of parameters for a portion of a sidelink resource pool currently in use by the UE is configured, then the UE may use the sidelink resource pool configuration. Thus, a UE (e.g., a UE having a threshold capability) can be configured with multiple configurations (indicating respective sets of parameters for multiple portions of a sidelink resource pool and/or a sidelink resource pool configuration), and may use an appropriate configuration of the multiple configurations according to which portion of the sidelink resource pool the UE uses for communication. In some aspects, two or more configurations, of the multiple configurations (corresponding to two or more different sidelink resource pools) may be the same as one another.

In some aspects, a portion of a sidelink resource pool can have a different configuration for a UE having a threshold capability than for a baseline UE. For example, when communicating in the portion of the sidelink resource pool, a UE having a threshold capability may use a first configuration and a baseline UE may use a second configuration different than the first configuration. In some aspects, the first configuration and/or the second configuration may include an indication that the

As shown, the configuration may indicate at least one transmit parameter specific to the portion of the sidelink resource pool. The at least one transmit parameter may be specific to the portion of the sidelink resource pool because the at least one transmit parameter is used for operations (e.g., transmissions, measurements, channel sensing, resource selection) within the portion of the sidelink resource pool and not for operations in the sidelink resource pool and outside of the portion of the sidelink resource pool. For example, a power control parameter that is specific to the portion of the sidelink resource pool may be used for transmissions within the portion of the sidelink resource pool and not for transmissions outside the portion of the sidelink resource pool.

In some aspects, a transmit parameter may include a power control parameter. A power control parameter is a parameter used to determine a transmit power of the UE. For example, a UE may determine a transmit power P_{PSSCH,SL}(i) for a PSSSCH using a formula P_{PSSCH,SL}(i)=min(P_{O,SL}+10log₁₀(2^{μ}·M_{RB}^{PSSCH}(i))+α_{SL}·PL_{SL}+Delta_{subRP}_{_{index}}, PCMAX). In this formula, P_{O,SL} is a power target value (which may indicate a power needed at a receiving device, and which may be referred to as a received power per resource block), α_{SL} is a fractional power control parameter, PL_{SL} is a sidelink path loss, Delta_{subRPindex} is a power control offset value, M_{RB}^{PSSCH}(i) is a PSSCH bandwidth expressed in terms of resource blocks, and PCMAX is a maximum UE output power value. In the above formula, the power target value, the fractional power control value, the power control offset value, and the maximum UE output power value may be considered transmit parameters, and may be configured for the portion of the sidelink resource pool. In some aspects, the configuration of the portion of the sidelink resource pool may indicate whether to derive a path loss for the above formula from a sidelink measurement (e.g., a measurement on a sidelink reference signal) or a downlink measurement (e.g., a measurement on a downlink reference signal). In some aspects, the path loss may be specific to the portion of the sidelink resource pool. For example, the path loss may be derived from a measurement performed in the portion of the sidelink resource pool.

The power control offset value may indicate an offset (e.g., in dBm or dB) that is applied to the transmit power when a UE is transmitting in the portion of the sidelink resource pool. For example, the power control offset value may cause a UE to reduce the UE's transmit power when transmitting in the portion of the sidelink resource pool, thereby reducing interference for UEs having a threshold capability in the sidelink resource pool. The power control offset value (and/or one or more other transmit parameters described herein) may be configured or indicated via Layer 3 (e.g., RRC) signaling, Layer 2 (e.g., MAC) signaling, or Layer 1 (e.g., dynamic, DCI) signaling. For example, the Layer 1 signaling may indicate a selected power control offset value from multiple configured (via Layer 3 or Layer 2 signaling) power control offset values. In some aspects, the power control offset value may be based at least in part on whether a UE having a threshold capability is available or present in the portion of the sidelink resource pool. For example, if the portion of the sidelink resource pool is configured for a UE having a threshold capability, then the configuration of the sidelink resource pool may include a power control offset parameter, and if the portion of the sidelink resource pool is not configured for a UE having a threshold capability, then the configuration of the sidelink resource pool may not include a power control offset parameter. Thus, UEs may perform closed-loop power control for the portion of the sidelink resource pool. A UE may apply one or more power control parameters, as described below in connection with transmission of sidelink communications in the portion of the sidelink resource pool at reference number 1040.

In some aspects, the at least one transmit parameter may include a channel sensing parameter. For example, the at least one transmit parameter may indicate a first time length defining a sensing window (e.g., T₀, described in connection with FIG. 8) (e.g., selected from configured or preconfigured values such as 100 ms or 1100 ms), a second time length defining a minimum length of a resource selection window (e.g., T_{2,min}, described in connection with FIG. 8) (e.g., which may be configured or preconfigured per priority and per subcarrier spacing as {1, 5, 10, 20}·2^{μ}, μ=0, 1, 2, 3 for SCS 15, 30, 60, and 120 kHz, respectively), or a combination thereof. In some aspects, the sensing window and/or the resource selection window may be longer in a portion of a sidelink resource pool that is associated with UEs having a threshold capability than in a portion of a sidelink resource pool that is not associated with UEs having a threshold capability. For example, providing a longer sensing window and/or resource selection window for baseline UEs may reduce interference, for UEs having a threshold capability, in a portion of a sidelink resource pool associated with the UEs having the threshold capability.

In some aspects, the at least one transmit parameter (e.g., a channel sensing parameter) may indicate an increment for a threshold for candidate resource identification. For example, the UE may perform resource selection using a threshold for candidate resource identification. If the proportion of available resources in the selection window (according to a threshold for candidate resource identification, which may be an RSRP threshold, an RSRQ threshold, or a signal-to-interference-plus-noise (SINR) threshold) is below a threshold (e.g., 20%), the UE may increase the threshold for candidate resource identification by an increment and repeat candidate resource identification. Available resources in the resource selection window may form the candidate resource set, which may be reported to higher layers, as described above. In some aspects, the increment for the threshold may be specific to a portion of a sidelink resource pool. For example, the configuration may indicate the increment. Thus, the threshold for candidate resource identification may be derived using the at least one transmit parameter (since incrementation of the threshold for candidate resource identification may be in accord with the at least one transmit parameter). Implementing different increments based on whether or not a portion of a sidelink resource pool is associated with UEs having a threshold capability may reduce interference for UEs having the threshold capability, since a UE is more likely to avoid selection of occupied resources with a smaller increment than with a larger increment.

In some aspects, the at least one transmit parameter may include a modulation and coding scheme (MCS) parameter. For example, the MCS parameter may indicate a restrictive MCS value (e.g., a maximum MCS, a minimum MCS, a set of allowed MCSs, a specific MCS) for transmission in the portion of the sidelink resource pool. As another example, the MCS parameter may indicate a restrictive MCS table (e.g., a particular MCS table, one or more permitted rows or entries of a one or more MCS tables) that can be used for transmission in the portion of the sidelink resource pool. In some aspects, the at least one transmit parameter may include an antenna port parameter. For example, the antenna port parameter may indicate a restrictive rank value (e.g., a maximum rank, a minimum rank, a set of allowed ranks, a specific rank) for transmission in the portion of the sidelink resource pool. As another example, the antenna port parameter may indicate a restrictive antenna port value (e.g., a maximum number of antenna ports, a minimum number of antenna ports, a set of allowed antenna ports or numbers of antenna ports, a specific number of antenna ports) for transmission in the portion of the sidelink resource pool. In some aspects, the at least one transmit parameter may indicate a beam parameter. For example, the at least one transmit parameter may indicate one or more beams (e.g., analog beams, digital beams, beam widths, beam directions, or a combination thereof) that are allowed in the portion of the sidelink resource pool, one or more beams that are disallowed in the portion of the sidelink resource pool, or a combination thereof. In some aspects, the beam parameter may be based at least in part on positioning information. For example, the beam parameter may indicate a particular beam that is disallowed based at least in part on a position of a UE (e.g., such that the UE's beam does not interfere with a UE having a threshold capability that is located in a coverage area of the beam).

In some aspects, the configuration may indicate whether a portion of a sidelink resource pool is associated with UEs having a threshold capability. For example, the configuration may indicate whether one or more UEs having a threshold capability are configured to communicate in the portion of the sidelink resource pool. In some aspects, the one or more transmit parameters of the configuration may apply for a portion of a sidelink resource pool that is associated with UEs having a threshold capability, and may not apply if the portion is not associated with UEs having a threshold capability.

The configuration shown by reference number 1020 can be signaled via Layer 1 signaling, Layer 2 signaling, Layer 3 signaling, or a combination thereof. In some aspects, the network entity may output, and the UE may receive, signaling updating the configuration shown by reference number 1020 (e.g., one or more transmit parameters). The signaling updating the configuration may include Layer 1 signaling, Layer 2 signaling, Layer 3 signaling, or a combination thereof.

As shown by reference number 1030, the UE may communicate based at least in part on the at least one transmit parameter. For example, the UE may transmit a communication in the portion of the sidelink resource pool using the at least one transmit parameter, as shown by reference number 1040. As another example, the UE may perform sensing and/or resource selection in the portion of the sidelink resource pool based at least in part on the at least one transmit parameter, as shown by reference number 1050. In some aspects, the UE may communicate based at least in part on the at least one transmit parameter based at least in part on an indication to use the at least one transmit parameter. For example, the network entity may provide an indication to start using the at least one transmit parameter (e.g., via Layer 1, Layer 2, and/or Layer 3 signaling). As another example, the network entity may provide an indication to cease using the at least one transmit parameter (e.g., via Layer 1, Layer 2, and/or Layer 3 signaling).

As shown by reference number 1040, the UE may transmit a communication in the portion of the sidelink resource pool using the at least one transmit parameter. For example, the UE may transmit the communication using at least one power control parameter, an MCS parameter, a beam parameter, an antenna port parameter, or a combination thereof. In some aspects, the UE may transmit the communication using the at least one transmit parameter if the UE is a baseline UE and the communication is in the portion of the sidelink resource pool. In some aspects, the UE may transmit the communication using the at least one transmit parameter if a UE having the threshold capability is associated with the portion of the sidelink resource pool (e.g., if the portion of the sidelink resource pool is configured for the UE having the threshold capability, or if the UE having the threshold capability is transmitting or receiving in the portion of the sidelink resource pool). For example, the network entity may provide an indication that the portion of the sidelink resource pool is configured for or in use by a UE having a threshold capability, or may provide an indication of a resource of the portion of the sidelink resource pool in use by the UE having the threshold capability. As another example, a UE having a threshold capability may transmit a reservation (e.g., SCI) for a resource in use by the UE having the threshold capability. The reservation may identify the UE having the threshold capability (e.g., may include an identifier of the UE or may indicate that the UE has the threshold capability). For such a resource or portion of a sidelink resource pool, in some aspects, the UE may not transmit within the resource or portion. In some other aspects, the UE may transmit within the resource or portion using the at least one transmit parameter described above (e.g., a power control parameter, an MCS parameter, or the like).

In some aspects, the UE may not communicate within the portion of the sidelink resource pool. For example, the UE may transmit a communication in the sidelink resource pool outside of the portion of the sidelink resource pool. This may be based on the portion of the sidelink resource pool being associated with UEs having a threshold capability, and/or based on the UE being a baseline UE.

As another example, the UE may perform sensing and/or resource selection in the portion of the sidelink resource pool based at least in part on the at least one transmit parameter, as shown by reference number 1050. For example, the UE may perform sensing according to a threshold for candidate resource identification, as described above. The threshold may be associated with an increment indicated by the at least one transmit parameter. The UE may identify resources that satisfy the threshold as a set of candidate resources. The UE may select, from the set of candidate resources, a resource for a transmission. For example, the UE may perform random selection from the set of candidate resources (e.g., using a random seed, a pseudo-random sequence, or the like). Thus, the selection of a resource for a transmission (which may be random) may be based on the at least one transmit parameter, since identification of the candidate resources from which the resource for the transmission is selected uses the threshold for candidate resource selection. As another example, the UE may exclude, from the set of candidate resources, a resource that is indicated as in use by a UE having a threshold capability (for example, based on signaling from a network entity or a reservation from the UE having the threshold capability.

In some aspects, the UE may transmit a communication based at least in part on the sensing and/or resource selection. For example, if a resource satisfies a threshold for candidate resource selection (e.g., an RSRP threshold, an RSRQ threshold, an SINR threshold) by less than a threshold amount (where the threshold amount may be indicated by the configuration via Layer 1, Layer 2, or Layer 3 signaling), the UE may apply the at least one transmit parameter for transmission on the resource. For example, the UE may apply the transmit power parameter and/or the MCS parameter for transmission on the resource.

As indicated above, FIG. 10 is provided as an example. Other examples may differ from what is described with regard to FIG. 10.

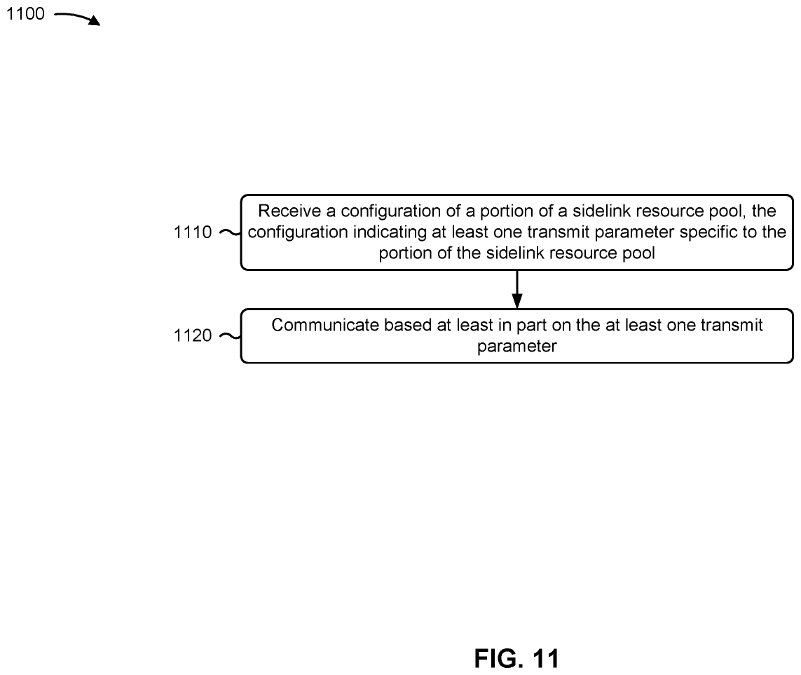

FIG. 11 shows a method 1100 for wireless communications by a UE, such as UE 120.

Method 1100 begins at 1110 with receiving a configuration of a portion of a sidelink resource pool, the configuration indicating at least one transmit parameter specific to the portion of the sidelink resource pool.

Method 1100 then proceeds to step 1120 with communicating based at least in part on the at least one transmit parameter.

In a first aspect, the at least one transmit parameter comprises at least one of a power control parameter, a channel sensing parameter, a modulation and coding scheme parameter, an antenna port parameter, or a beam parameter.

In a second aspect, alone or in combination with the first aspect, the at least one transmit parameter comprises the power control parameter, and the power control parameter includes at least one of a maximum UE output power value, a path loss value, a fractional power control parameter, a power target value, or a power control offset value.

In a third aspect, alone or in combination with one or more of the first and second aspects, the at least one transmit parameter comprises the channel sensing parameter, and the channel sensing parameter includes at least one of a first time length defining a sensing window, or a second time length defining a minimum length of a resource selection window.

In a fourth aspect, alone or in combination with one or more of the first through third aspects, the at least one transmit parameter comprises the channel sensing parameter, and the channel sensing parameter indicates an increment for a threshold for candidate resource identification.

In a fifth aspect, alone or in combination with one or more of the first through fourth aspects, communicating based at least in part on the at least one transmit parameter comprises transmitting a communication in the sidelink resource pool using the at least one transmit parameter.

In a sixth aspect, alone or in combination with one or more of the first through fifth aspects, communicating based at least in part on the at least one transmit parameter comprises performing sensing of the sidelink resource pool using a threshold derived using the at least one transmit parameter.

In a seventh aspect, alone or in combination with one or more of the first through sixth aspects, method 1100 includes selecting a resource in the sidelink resource pool using random selection based at least in part on performing the sensing of the sidelink resource pool using the threshold, and transmitting on the resource.

In an eighth aspect, alone or in combination with one or more of the first through seventh aspects, method 1100 includes transmitting on the resource using the at least one transmit parameter.

In a ninth aspect, alone or in combination with one or more of the first through eighth aspects, the configuration indicates that the portion of the sidelink resource pool is associated with UEs having a threshold capability.

In a tenth aspect, alone or in combination with one or more of the first through ninth aspects, communicating based at least in part on the at least one transmit parameter further comprises communicating outside of the portion of the sidelink resource pool.

In an eleventh aspect, alone or in combination with one or more of the first through tenth aspects, method 1100 includes transmitting in the resource using the one or more transmit parameters.

In a twelfth aspect, alone or in combination with one or more of the first through eleventh aspects, method 1100 includes transmitting on the resource using the one or more transmit parameters.

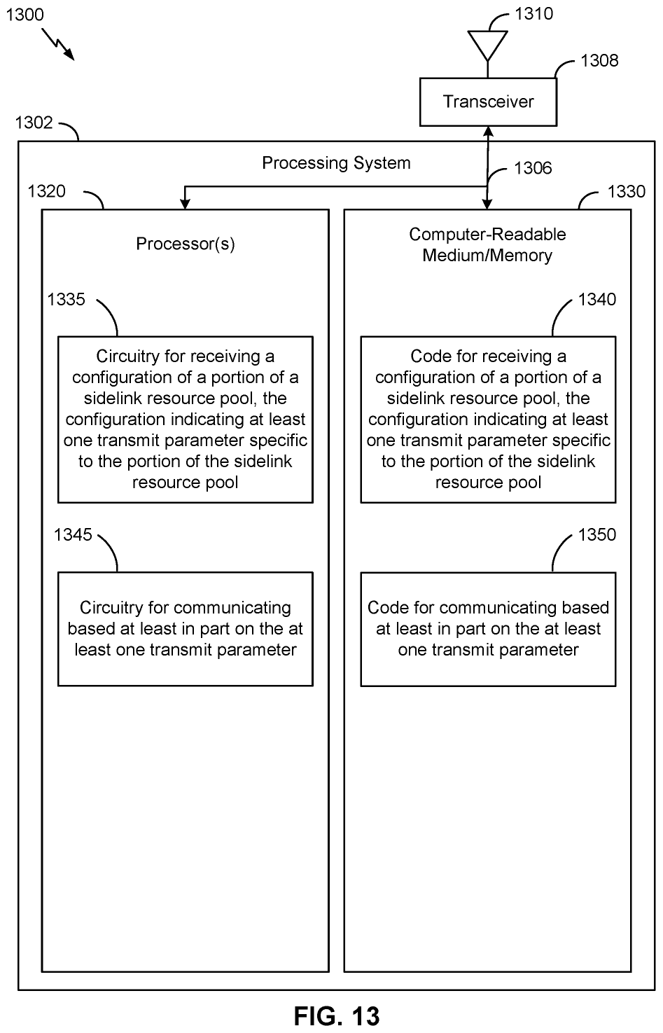

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

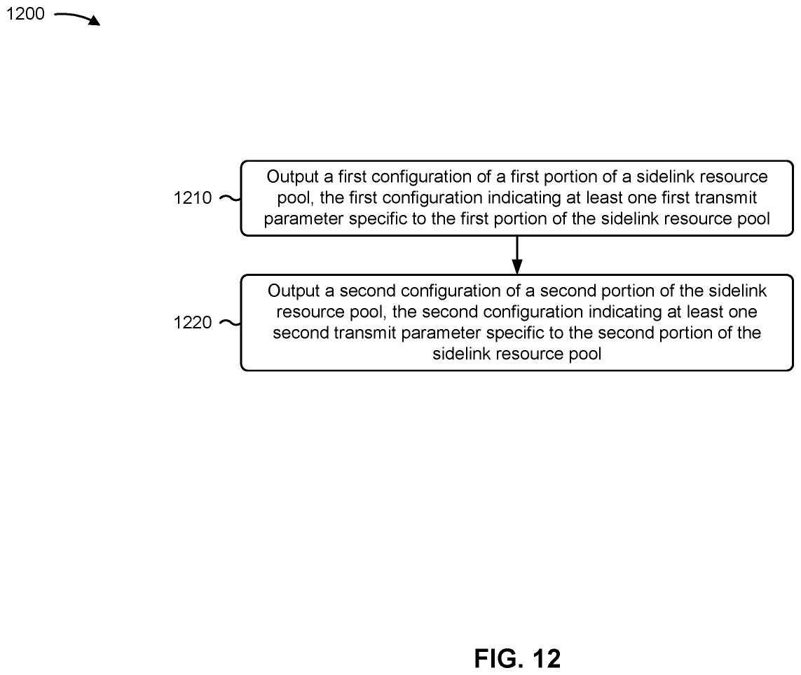

FIG. 12 shows a method 1200 for wireless communications by a network entity, such as BS 110, or a disaggregated base station as discussed with respect to FIG. 3.

Method 1200 begins at 1210 with outputting a first configuration of a first portion of a sidelink resource pool, the first configuration indicating at least one first transmit parameter specific to the first portion of the sidelink resource pool.

Method 1200 then proceeds to step 1220 with outputting a second configuration of a second portion of the sidelink resource pool, the second configuration indicating at least one second transmit parameter specific to the second portion of the sidelink resource pool.

In a first aspect, the at least one transmit parameter comprises at least one of a power control parameter, a channel sensing parameter, a modulation and coding scheme parameter, an antenna port parameter, or a beam parameter.

In a second aspect, alone or in combination with the first aspect, the at least one transmit parameter comprises the power control parameter, and the power control parameter includes at least one of a maximum UE output power value, a path loss value, a fractional power control parameter, a power target value, or a power control offset value.

In a third aspect, alone or in combination with one or more of the first and second aspects, the at least one transmit parameter comprises the channel sensing parameter, and the channel sensing parameter includes at least one of a first time length defining a sensing window, or a second time length defining a minimum length of a resource selection window.

In a fourth aspect, alone or in combination with one or more of the first through third aspects, the at least one transmit parameter comprises the channel sensing parameter, and the channel sensing parameter indicates an increment for a threshold for candidate resource identification.

In a fifth aspect, alone or in combination with one or more of the first through fourth aspects, the configuration indicates that the first portion of the sidelink resource pool is associated with UEs having a threshold capability.

In a sixth aspect, alone or in combination with one or more of the first through fifth aspects, method 1200 includes outputting an indication of a resource, of the first portion of the sidelink resource pool, reserved for a particular UE having a threshold capability.

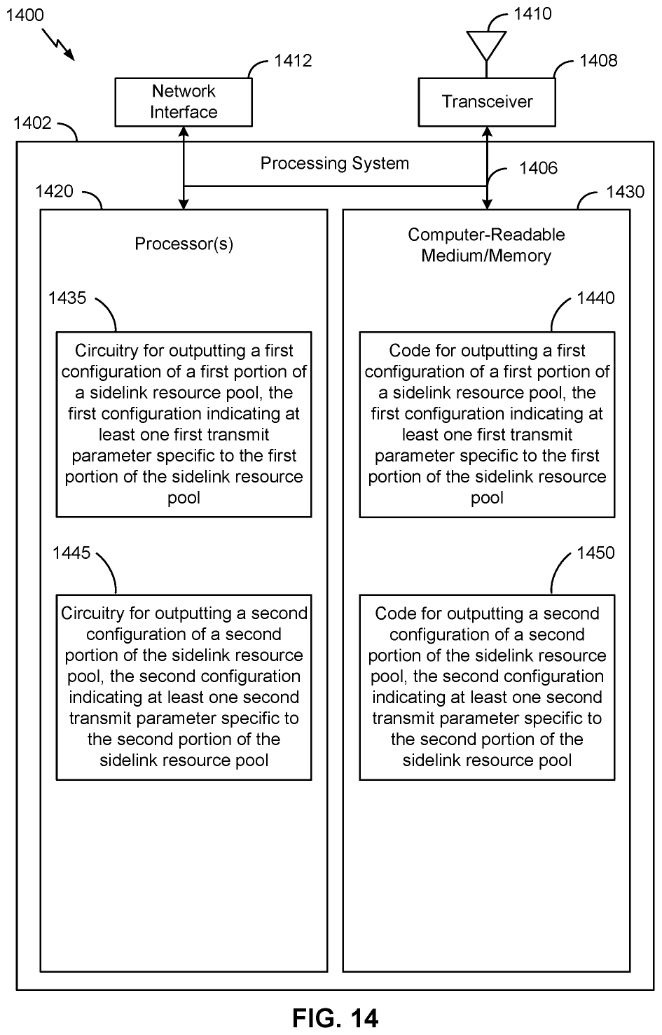

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

FIG. 13 is a diagram illustrating an example of an implementation of code and circuitry for a communications device 1300. The communications device 1300 may be a UE, or a UE may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may be representative of memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300.

As shown in FIG. 13, the communications device 1300 may include circuitry for receiving a configuration of a portion of a sidelink resource pool, the configuration indicating at least one transmit parameter specific to the portion of the sidelink resource pool (circuitry 1335).

As shown in FIG. 13, the communications device 1300 may include, stored in computer-readable medium/memory 1330, code for receiving a configuration of a portion of a sidelink resource pool, the configuration indicating at least one transmit parameter specific to the portion of the sidelink resource pool (code 1340).

As shown in FIG. 13, the communications device 1300 may include circuitry for communicating based at least in part on the at least one transmit parameter (circuitry 1345).

As shown in FIG. 13, the communications device 1300 may include, stored in computer-readable medium/memory 1330, code for communicating based at least in part on the at least one transmit parameter (code 1350).

Various components of the communications device 1300 may provide means for performing the method 1100 described with respect to FIG. 11, or any aspect related to it. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

FIG. 14 is a diagram illustrating an example of an implementation of code and circuitry for a communications device 1400. The communications device 1400 may be a network entity (such as BS 110 or a disaggregated base station as described with regard to FIG. 3), or a network entity may include the communications device 1400.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The network interface 1412 is configured to obtain and send signals for the communications device 1400 via communications link(s), such as a backhaul link, midhaul link, and/or fronthaul link as described herein, such as with respect to FIG. 3. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 238, transmit processor 220, TX MIMO processor 230, and/or controller/processor 240, as described with respect to FIG. 2. The one or more processors 1420 are coupled to a computer-readable medium/memory 1430 via a bus 1406. In various aspects, the computer-readable medium/memory 1430 may be representative of memory 242, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 1200 described with respect to FIG. 12, or any aspect related to it. Note that reference to a processor performing a function of communications device 1400 may include one or more processors performing that function of communications device 1400.

As shown in FIG. 14, the communications device 1400 may include circuitry for outputting a first configuration of a first portion of a sidelink resource pool, the first configuration indicating at least one first transmit parameter specific to the first portion of the sidelink resource pool (circuitry 1435).

As shown in FIG. 14, the communications device 1400 may include, stored in computer-readable medium/memory 1430, code for outputting a first configuration of a first portion of a sidelink resource pool, the first configuration indicating at least one first transmit parameter specific to the first portion of the sidelink resource pool (code 1440).

As shown in FIG. 14, the communications device 1400 may include circuitry for outputting a second configuration of a second portion of the sidelink resource pool, the second configuration indicating at least one second transmit parameter specific to the second portion of the sidelink resource pool (circuitry 1445).

As shown in FIG. 14, the communications device 1400 may include, stored in computer-readable medium/memory 1430, code for outputting a second configuration of a second portion of the sidelink resource pool, the second configuration indicating at least one second transmit parameter specific to the second portion of the sidelink resource pool (code 1450).

Various components of the communications device 1400 may provide means for performing the method 1200 described with respect to FIG. 12, or any aspect related to it. For example, means for transmitting, sending, or outputting for transmission may include the transceiver(s) 232 and/or antenna(s) 234 of the BS 110 and/or transceiver 1408 and antenna 1410 of the communications device 1400 in FIG. 14. Means for receiving or obtaining may include the transceiver(s) 232 and/or antenna(s) 234 of the BS 110 and/or transceiver 1408 and antenna 1410 of the communications device 1400 in FIG. 14.

FIG. 14 is provided as an example. Other examples may differ from what is described in connection with FIG. 14.

The following provides an overview of some Aspects of the present disclosure:

Aspect 1: A method of wireless communication performed by a user equipment (UE), comprising: receiving a configuration of a portion of a sidelink resource pool, the configuration indicating at least one transmit parameter specific to the portion of the sidelink resource pool, and communicating based at least in part on the at least one transmit parameter.

Aspect 2: The method of Aspect 1, wherein the at least one transmit parameter comprises at least one of: a power control parameter, a channel sensing parameter, a modulation and coding scheme parameter, an antenna port parameter, or a beam parameter.

Aspect 3: The method of Aspect 2, wherein the at least one transmit parameter comprises the power control parameter, and wherein the power control parameter includes at least one of: a maximum UE output power value, a path loss value, a fractional power control parameter, a power target value, or a power control offset value.

Aspect 4: The method of Aspect 2, wherein the at least one transmit parameter comprises the channel sensing parameter, and wherein the channel sensing parameter includes at least one of: a first time length defining a sensing window, or a second time length defining a minimum length of a resource selection window.

Aspect 5: The method of Aspect 2, wherein the at least one transmit parameter comprises the channel sensing parameter, and wherein the channel sensing parameter indicates an increment for a threshold for candidate resource identification.

Aspect 6: The method of any of Aspects 1-5, wherein communicating based at least in part on the at least one transmit parameter comprises transmitting a communication in the sidelink resource pool using the at least one transmit parameter.

Aspect 7: The method of any of Aspects 1-6, wherein communicating based at least in part on the at least one transmit parameter comprises performing sensing of the sidelink resource pool using a threshold derived using the at least one transmit parameter.

Aspect 8: The method of Aspect 7, further comprising selecting a resource in the sidelink resource pool using random selection based at least in part on performing the sensing of the sidelink resource pool using the threshold; and transmitting on the resource.

Aspect 9: The method of any of Aspects 1-8, further comprising performing random selection of a resource for a transmission, wherein communicating based at least in part on the at least one transmit parameter further comprises transmitting on the resource using the at least one transmit parameter.

Aspect 10: The method of any of Aspects 1-9, wherein the configuration indicates that the portion of the sidelink resource pool is associated with UEs having a threshold capability.

Aspect 11: The method of any of Aspects 1-10, wherein communicating based at least in part on the at least one transmit parameter further comprises communicating outside of the portion of the sidelink resource pool.

Aspect 12: The method of any of Aspects 1-11, further comprising receiving an indication of a resource, of the portion of the sidelink resource pool, reserved for a particular UE having a threshold capability, wherein communicating based at least in part on the at least one transmit parameter further comprises transmitting in the resource using the one or more transmit parameters.

Aspect 13: The method of any of Aspects 1-12, further comprising receiving a reservation, for a resource in the portion of the sidelink resource pool, from a particular UE having a threshold capability, wherein communicating based at least in part on the configuration further comprises transmitting on the resource using the one or more transmit parameters.

Aspect 14: A method of wireless communication performed by a network entity, comprising: outputting a first configuration of a first portion of a sidelink resource pool, the first configuration indicating at least one first transmit parameter specific to the first portion of the sidelink resource pool; and outputting a second configuration of a second portion of the sidelink resource pool, the second configuration indicating at least one second transmit parameter specific to the second portion of the sidelink resource pool.

Aspect 15: The method of Aspect 14, wherein the at least one transmit parameter comprises at least one of: a power control parameter, a channel sensing parameter, a modulation and coding scheme parameter, an antenna port parameter, or a beam parameter.

Aspect 16: The method of Aspect 15, wherein the at least one transmit parameter comprises the power control parameter, and wherein the power control parameter includes at least one of: a maximum UE output power value, a path loss value, a fractional power control parameter, a power target value, or a power control offset value.

Aspect 17: The method of Aspect 15, wherein the at least one transmit parameter comprises the channel sensing parameter, and wherein the channel sensing parameter includes at least one of: a first time length defining a sensing window, or a second time length defining a minimum length of a resource selection window.

Aspect 18: The method of Aspect 15, wherein the at least one transmit parameter comprises the channel sensing parameter, and wherein the channel sensing parameter indicates an increment for a threshold for candidate resource identification.

Aspect 19: The method of any of Aspects 14-18, wherein the configuration indicates that the first portion of the sidelink resource pool is associated with UEs having a threshold capability.

Aspect 20: The method of any of Aspects 14-19, further comprising outputting an indication of a resource, of the first portion of the sidelink resource pool, reserved for a particular UE having a threshold capability.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) for wireless communication, comprising:
a memory; and
one or more processors, coupled to the memory, configured to:
receive a configuration of a portion of a sidelink resource pool, the configuration indicating at least one transmit parameter specific to the portion of the sidelink resource pool, and
communicate based at least in part on the at least one transmit parameter.

2. The UE of claim 1, wherein the at least one transmit parameter comprises at least one of:
a power control parameter,
a channel sensing parameter,
a modulation and coding scheme parameter,
an antenna port parameter, or
a beam parameter.

3. The UE of claim 2, wherein the at least one transmit parameter comprises the power control parameter, and wherein the power control parameter includes at least one of:
a maximum UE output power value,
a path loss value,
a fractional power control parameter,
a power target value, or
a power control offset value.

4. The UE of claim 2, wherein the at least one transmit parameter comprises the channel sensing parameter, and wherein the channel sensing parameter includes at least one of:
a first time length defining a sensing window, or
a second time length defining a minimum length of a resource selection window.

5. The UE of claim 2, wherein the at least one transmit parameter comprises the channel sensing parameter, and wherein the channel sensing parameter indicates an increment for a threshold for candidate resource identification.

6. The UE of claim 1, wherein the one or more processors, to communicate based at least in part on the at least one transmit parameter, are configured to transmit a communication in the sidelink resource pool using the at least one transmit parameter.

7. The UE of claim 1, wherein the one or more processors, to communicate based at least in part on the at least one transmit parameter, are configured to perform sensing of the sidelink resource pool using a threshold derived using the at least one transmit parameter.

8. The UE of claim 7, wherein the one or more processors are further configured to select a resource in the sidelink resource pool using random selection based at least in part on performing the sensing of the sidelink resource pool using the threshold; and
transmit on the resource.

9. The UE of claim 1, wherein the one or more processors are further configured to perform random selection of a resource for a transmission, wherein, to communicate based at least in part on the at least one transmit parameter, the one or more processors are further configured to transmit on the resource using the at least one transmit parameter.

10. The UE of claim 1, wherein the configuration indicates that the portion of the sidelink resource pool is associated with UEs having a threshold capability.

11. The UE of claim 1, wherein the one or more processors, to communicate based at least in part on the at least one transmit parameter, are configured to communicate outside of the portion of the sidelink resource pool.

12. The UE of claim 1, wherein the one or more processors are further configured to receive an indication of a resource, of the portion of the sidelink resource pool, reserved for a particular UE having a threshold capability, wherein, to communicate based at least in part on the at least one transmit parameter, the one or more processors are further configured to transmit in the resource using the one or more transmit parameters.

13. The UE of claim 1, wherein the one or more processors are further configured to receiving a reservation, for a resource in the portion of the sidelink resource pool, from a particular UE having a threshold capability, wherein, to communicate based at least in part on the configuration, the one or more processors are further configured to transmit on the resource using the one or more transmit parameters.

14. A network entity for wireless communication, comprising:
a memory; and
one or more processors, coupled to the memory, configured to:
output a first configuration of a first portion of a sidelink resource pool, the first configuration indicating at least one first transmit parameter specific to the first portion of the sidelink resource pool; and
output a second configuration of a second portion of the sidelink resource pool, the second configuration indicating at least one second transmit parameter specific to the second portion of the sidelink resource pool.

15. The network entity of claim 14, wherein the at least one transmit parameter comprises at least one of:
a power control parameter,
a channel sensing parameter,
a modulation and coding scheme parameter,
an antenna port parameter, or
a beam parameter.

16. The network entity of claim 15, wherein the at least one transmit parameter comprises the power control parameter, and wherein the power control parameter includes at least one of:
a maximum UE output power value,
a path loss value,
a fractional power control parameter,
a power target value, or
a power control offset value.

17. The network entity of claim 15, wherein the at least one transmit parameter comprises the channel sensing parameter, and wherein the channel sensing parameter includes at least one of:
a first time length defining a sensing window, or
a second time length defining a minimum length of a resource selection window.

18. The network entity of claim 15, wherein the at least one transmit parameter comprises the channel sensing parameter, and wherein the channel sensing parameter indicates an increment for a threshold for candidate resource identification.

19. The network entity of claim 14, wherein the first configuration indicates that the first portion of the sidelink resource pool is associated with UEs having a threshold capability.

20. The network entity of claim 14, wherein the one or more processors are further configured to output an indication of a resource, of the first portion of the sidelink resource pool, reserved for a particular UE having a threshold capability.

21. A method of wireless communication performed by a user equipment (UE), comprising:
receiving a configuration of a portion of a sidelink resource pool, the configuration indicating at least one transmit parameter specific to the portion of the sidelink resource pool, and
communicating based at least in part on the at least one transmit parameter.

22. A method of wireless communication performed by a network entity, comprising:
outputting a first configuration of a first portion of a sidelink resource pool, the first configuration indicating at least one first transmit parameter specific to the first portion of the sidelink resource pool; and
outputting a second configuration of a second portion of the sidelink resource pool, the second configuration indicating at least one second transmit parameter specific to the second portion of the sidelink resource pool.
